(19) United States
(12) Patent Application Publication
(10) Pub. No.: US 2021/0057126 A1
(43) Pub. Date: Feb. 25, 2021

(54) INSULATED WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Jisung KIM, Yokkaichi-shi (JP); Daisuke HASHIMOTO, Yokkaichi-shi (JP); Dohyung KIM, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/982,851

(22) PCT Filed: Mar. 22, 2019
(86) PCT No.: PCT/JP2019/011971

§ 371 Date: Sep. 21, 2020

(30) Foreign Application Priority Data
Apr. 6, 2018 (JP) 2018-074021

(51) Int. Cl. H01B 7/04; H01B 7/00

(52) U.S. Cl. CPC H01B 7/04; H01B 7/0009

(57) ABSTRACT

An insulated wire is provided with a good balance between flexibility and strength, with both flexibility and strength being appropriately ensured. An insulated wire (1) includes a plurality of first stranded wires (2), a plurality of second stranded wires (3), and a cover member (4). The first stranded wires (2) each include a plurality of first wires (21) twisted together. The second stranded wires (3) each include a plurality of second wires (31) twisted together, the second wires (31) having a wire diameter smaller than that of the first wires (21). The plurality of first stranded wires (2) are disposed in or near the center portion of the insulated wire (1) and are twisted in a circumferential direction C. The plurality of second stranded wires (3) are disposed at the outer circumference surrounding the plurality of first stranded wires (2) and are twisted in the circumferential direction C.

### BACKGROUND

The present disclosure relates to an insulated wire including a plurality of kinds of stranded wires with different wire diameters for wires.

When wiring for different kinds of electronic controllers is performed, an insulated wire including a plurality of wires and an insulator covering the outer circumference of the plurality of wires is used. Also, the insulated wire is generally formed from a plurality of stranded wires, each including a plurality of twisted wires, as such wires are easily installed or routed.

For example, a flex-resistant wire according to JP 2016-197569A includes a multiple-stranded wire. The multiple-stranded wire includes a plurality of bunched stranded wires twisted together, wherein each of the bunched stranded wires include a plurality of conductive wires twisted together. Also, described is the lay length of the plurality of bunched stranded wire in the multiple-stranded wire being set to be equal to or greater than the lay length of the plurality of wires in the bunched stranded wire.

### SUMMARY

To facilitate installation and routing, there is a demand for insulated wires to have high flexibility (flex easily). Also, there is a demand for insulated wires for use in environments susceptible to vibrations such as when installed in a vehicle to have high strength (rigidity) in terms of resonance resistance, which indicates resistance to resonance.

To increase the flexibility of the insulated wire, strength must be decreased. To increase the strength of the insulated wire, flexibility must be decreased. In other words, flexibility and strength have a negative correlation that makes increasing both difficult.

Accordingly, there is a demand for the development of an insulated wire that can obtain moderately increased flexibility and strength in a balanced manner. Research by the inventors found a way of arranging a plurality of kinds of stranded wires in a manner by which flexibility and strength can be effectively increased. In JP 2016-197569A, the flex-resistant wire is described as including a plurality of bunched stranded wires bunched together. However, there is no mention of using a plurality of kinds of stranded wires.

An exemplary aspect of the disclosure provides an insulated wire with a good balance between flexibility and strength, with both flexibility and strength being appropriately ensured.

A first aspect of the present disclosure is an insulated wire including: a plurality of first stranded wires each formed by twisting a plurality of first wires; a plurality of second stranded wires each formed by twisting a plurality of second wires, the second wires having a wire diameter different from a wire diameter of the first wires; and a cover with insulating properties that covers an entire outer circumference of the plurality of first stranded wires and the plurality of second stranded wire as a whole, wherein the plurality of first stranded wires are twisted in a circumferential direction, and the plurality of second stranded wires are twisted in the circumferential direction at an outer circumference surrounding the plurality of first stranded wires.

A second aspect of the present disclosure is an insulated wire including one or a plurality of first stranded wires each formed by twisting a plurality of first wires; a plurality of second stranded wires each formed by twisting a plurality of second wires, the second wires having a wire diameter smaller than a wire diameter of the first wires; and a cover with insulating properties that covers an entire outer circumference of the plurality of first stranded wires and the plurality of second stranded wires as a whole, wherein the one or plurality of first stranded wires are disposed in a center portion of the insulated wire, and the plurality of second stranded wires are disposed in an outer circumferential portion surrounding the one or plurality of first stranded wires, in a state of being twisted in a circumferential direction.

Insulated Wire According to the First Aspect

A first advantage of the insulated wire of the first aspect is that two kinds of stranded wires with different wire diameters for wires, the first stranded wires and the second stranded wires, are used. By using one of the first stranded wires or the second stranded wires which includes the wires from among the first wires and the second wires with the smaller wire diameter, the flexibility of the insulated wire can be ensured. Also, by using the other one of the first stranded wires or the second stranded wires which includes the wires from among the first wires and the second wires with the greater wire diameter, the strength of the insulated wire can be ensured.

A second advantage of the insulated wire of the first aspect is that the plurality of first stranded wires including the first wires are twisted together and the plurality of second stranded wires including the second wires are twisted together at the outer circumference surrounding the plurality of first stranded wires. In other words, the plurality of first stranded wires and the plurality of second stranded wires are separately twisted. This can appropriately increase the vibrational strength of the insulated wire. Also, because the plurality of first stranded wires and the plurality of second stranded wires are separately twisted, the twisting operation is easily performed. This can prevent the occurrence of insufficient twisting.

Thus, according to the insulated wire of the first aspect, by combining these two advantages, the insulated wire can be formed with a good balance between flexibility and strength, with both flexibility and strength being appropriately ensured.

Insulated Wire According to the Second Aspect

A first advantage of the insulated wire of the second aspect is that two kinds of stranded wires with different wire diameters for wires, the first stranded wires and the second stranded wires, are used. By using the second stranded wires including the second wires with a wire diameter smaller than that of the first wires, the flexibility of the insulated wire can be ensured. Also, by using the first stranded wires including the first wires with a wire diameter greater than that of the second wires, the strength of the insulated wire can be ensured.

A second advantage of the insulated wire of the second aspect is that the plurality of second stranded wires are disposed at an outer circumferential portion surrounding the first stranded wires in a state of being twisted together. In other words, the first stranded wires including the first wires, which have a greater wire diameter, are disposed in the center portion of the insulated wire. This allows the strength of the insulated wire to be appropriately increased. Also, the second stranded wires including the second wires, which have a smaller wire diameter, are disposed in the outer circumferential portion of the insulated wire. This allows the flexibility of the insulated wire to be appropriately increased.

Thus, according to the insulated wire of the second aspect, by combining these two advantages, the insulated wire can be formed with a good balance between flexibility and strength, with both flexibility and strength being appropriately ensured.

### BRIEF DESCRIPTION OF THE DRAWINGS

FIG. 1 is an explanatory diagram showing a cross-section of an insulated wire according to a first embodiment.

FIG. 2 is a perspective view showing a first stranded wire including a plurality of first wires twisted together according to the first embodiment.

FIG. 3 is a perspective view showing a second stranded wire including a plurality of second wires twisted together according to the first embodiment.

FIG. 4 is a perspective view showing a first stranded wire group including a plurality of first stranded wires twisted together according to the first embodiment.

FIG. 5 is a perspective view showing a second stranded wire group including a plurality of second stranded wires twisted together about the first stranded wire group according to the first embodiment.

FIG. 6 schematically shows how the strength and flexibility of a wire changes relative to the diameter of the wire according to the first embodiment.

FIG. 7 is an explanatory diagram showing a cross-section of an insulated wire according to a second embodiment.

FIG. 8 is an explanatory diagram showing a cross-section of another insulated wire according to the second embodiment.

FIG. 9 is an explanatory diagram showing a cross-section of another insulated wire according to the second embodiment.

FIG. 10 is an explanatory diagram showing a cross-section of another insulated wire according to the second embodiment.

FIG. 11 is an explanatory diagram showing a cross-section of another insulated wire according to the second embodiment.

FIG. 12 is an explanatory diagram showing a cross-section of an insulated wire according to a third embodiment.

FIG. 13 is an explanatory diagram showing a cross-section of an insulated wire according to a fourth embodiment.

### DETAILED DESCRIPTION OF EMBODIMENTS

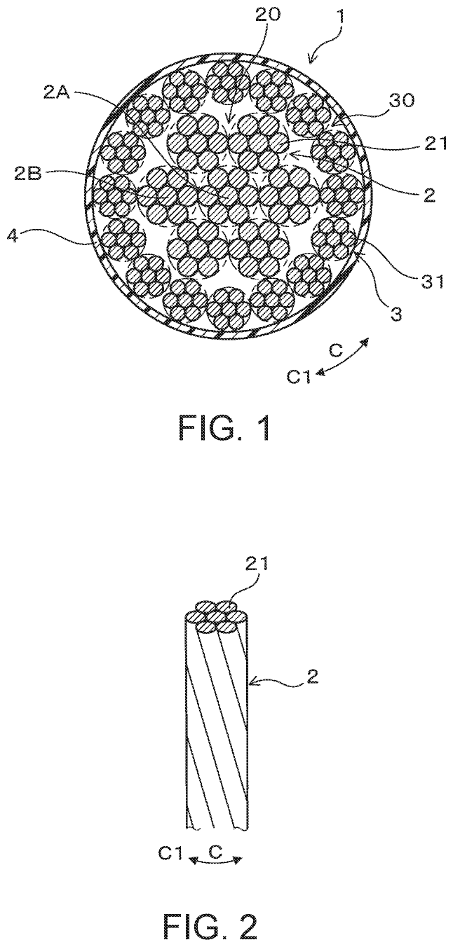

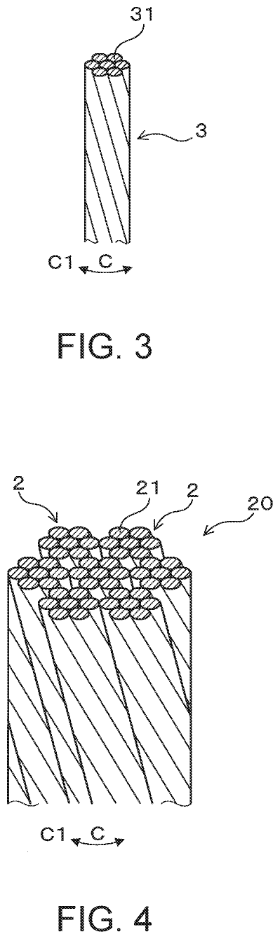

The insulated wire according to preferred embodiments will be described with reference to the drawings. As shown in FIG. 1, an insulated wire 1 of the present embodiment includes a plurality of first stranded wires 2, a plurality of second stranded wires 3, and a cover member 4 (cover). As shown in FIG. 2, the first stranded wires 2 each include a plurality of first wires 21 twisted together. As shown in FIG. 3, the second stranded wires 3 each include a plurality of second wires 31 twisted together, the second wires 31 having a wire diameter (diameter) smaller than that of the first wires 21. As shown in FIG. 1, the cover member 4 is formed at the outermost circumferential portion of the insulated wire 1 and covers the entire outer circumference of the bunched plurality of first stranded wires 2 and the plurality of second stranded wires 3 as a whole.

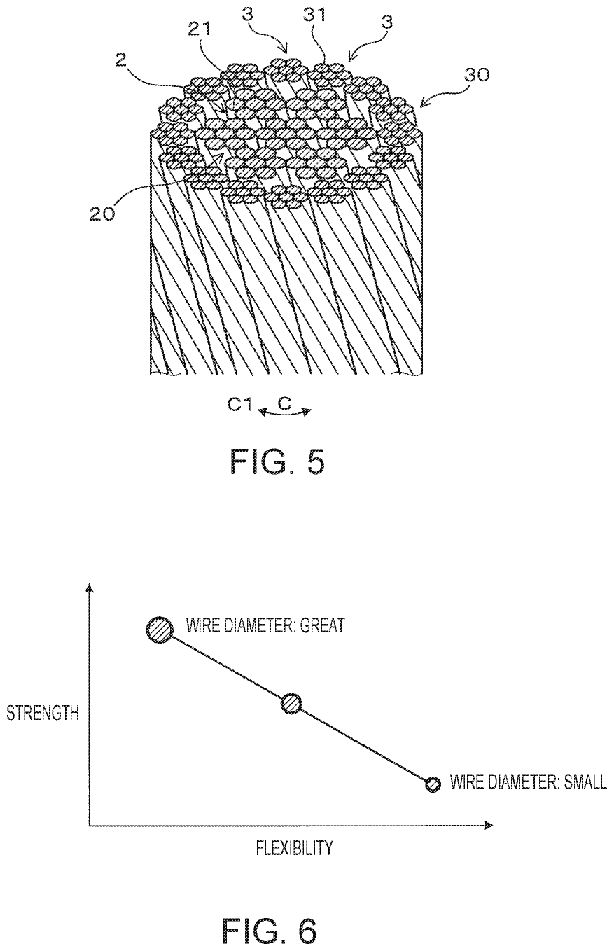

As shown in FIG. 4, the plurality of first stranded wires 2 are disposed in or near the center portion of the insulated wire 1 and are twisted in a circumferential direction C. As shown in FIG. 5, the plurality of second stranded wires 3 are disposed at the outer circumference surrounding the plurality of first stranded wires 2 and are twisted in the circumferential direction C.

The insulated wire 1 of the present embodiment will be described below.

Insulated Wire 1

The insulated wire 1 is for use in a vehicle and may be used in the wiring of various electrical controllers installed in a vehicle. The insulated wire 1 are bent and folded back in a curved manner when connected to the electrical controllers. Thus, the insulated wire 1 is required to have flexibility (be easy to flex) to facilitate being bent. Also, the insulated wire 1 receives vibration when the vehicle is running and thus requires strength (rigidity), in particular resonance resistance to resist resonance.

First Wires 21 and Second Wires 31

As shown in FIGS. 1 to 3, the first wires 21 and the second wires 31 are both formed from a metal material with good conductivity such as a copper material, for example copper or an alloy thereof. The first wires 21 have a wire diameter (diameter) within a range of from 0.2 to 1.0 mm. The second wires 31 have a wire diameter (diameter) within a range of from 0.05 to 0.5 mm. The wire diameter of the first wire 21 can be set to from 1.5 to 4 times the size of the wire diameter of the second wire 31.

The insulated wire 1 includes a conductor including the plurality of first stranded wires 2 and the plurality of second stranded wires 3 and the cover member 4. The plurality of first stranded wires 2 and the plurality of second stranded wires 3 may be formed as a single conductor. A cover layer is not formed around the outer circumference of the first stranded wires 2 nor around the outer circumference of the second stranded wires 3. The first stranded wires 2 are not insulated from one another, the second stranded wires 3 are not insulated from one another, and the first stranded wires 2 and the second stranded wires 3 are not insulated from one another.

First Stranded Wires 2

As shown in FIGS. 1, 4, and 5, the number of the first wires 21 forming each of the first stranded wires 2 can be from 3 to 1000. The number of the second wires 31 forming each of the second stranded wires 3 can be from 3 to 10000. The plurality of first wires 21 forming the first stranded wire 2 are disposed to give the first stranded wire 2 a substantially circular cross-section and are twisted with a twist to a first side C1 in the circumferential direction C. The plurality of second wires 31 forming the second stranded wire 3 are disposed to give the second stranded wire 3 a substantially circular cross-section and are twisted with a twist to the first side C1 in the circumferential direction C.

As shown in FIGS. 4 and 5, the plurality of first wires 21 of the first stranded wire 2 and the plurality of second wires 31 of the second stranded wire 3 are disposed in a spiral-like manner. The twist direction of the plurality of first wires 21 of the first stranded wire 2 and the twist direction of the plurality of second wires 31 of the second stranded wire 3 are the same.

The lay length of the plurality of first wires 21 of the first stranded wire 2 and the lay length of the plurality of second wires 31 of the second stranded wire 3 can be the same. Also, the lay length of the plurality of first wires 21 and the lay length of the plurality of second wires 31 can be different. Lay length refers to the length when the wire 21, 31, or the like, is twisted one whole time in the circumferential direction C.

To form the first stranded wire 2, the plurality of first wires 21 may be formed side by side in an imaginary circle, as seen from a cross-section of the plurality of first wires 21, and the first wires 21 may be twisted as a whole in the circumferential direction C to twist the first wires 21 as a whole. The second stranded wire 3 is formed from the plurality of second wires 31 in a similar manner.

When the plurality of first wires 21 are twisted to form the first stranded wire 2, the first wires 21 are compressed as appropriate. This allows the gaps between the first wires 21 to be decreased and the cross-sectional shape of the first stranded wire 2 to be formed in a substantially perfect circular shape. The second stranded wire 3 is formed from the plurality of second wires 31 in a similar manner.

As shown in FIGS. 1 to 5, for the sake of convenience, the number of the first wires 21 shown forming the first stranded wires 2 and the number of the second wires 31 shown forming the second stranded wires 3 is six. Also, for the sake of convenience, the number of the second stranded wires 3 shown is 16.

First Stranded Wire Group 20

As shown in FIG. 1, the plurality of first stranded wires 2 are formed as a first stranded wire group 20 including a central first stranded wire 2A disposed in the center portion of the insulated wire 1 and a plurality of outer circumference first stranded wires 2B disposed at the outer circumference surrounding the central first stranded wire 2A. The bundle of the plurality of first stranded wires 2 is defined as the first stranded wire group 20. When the plurality of first stranded wires 2 are twisted in the circumferential direction C, the plurality of outer circumference first stranded wires 2B are twisted to the first side C1 in the circumferential direction C by being twisted about the central first stranded wire 2A.

As shown in FIG. 4, in the first stranded wire group 20, the plurality of first stranded wires 2 are disposed in a spiral-like manner. In the present embodiment, the number of the central first stranded wires 2A is one and the number of the outer circumference first stranded wires 2B is six, bringing the total number of the first stranded wires 2 to seven. The total number of the first stranded wires 2 may be from 1 to 350.

Also, in the first stranded wire group 20, the central first stranded wire 2A and the outer circumference first stranded wires 2B are not required to be distinctly separated from one another. To form the first stranded wire group 20, the plurality of first stranded wires 2 may be formed side by side in an imaginary circle, as seen from a cross-section of the plurality of first stranded wires 2, and the first stranded wires 2 may be twisted as a whole in the circumferential direction C to twist the first stranded wires 2 as a whole. In this case, the central first stranded wire 2A may change to an outer circumference first stranded wire 2B as appropriate.

The plurality of outer circumference first stranded wires 2B may be twisted to the first side C1 in the circumferential direction C by rotating the plurality of outer circumference first stranded wires 2B around the central first stranded wire 2A. Also, the central first stranded wire 2A may be a twist core (center shaft) for when the plurality of first stranded wires 2 are twisted and may be barely twisted in the circumferential direction C. Furthermore, the twist direction of the plurality of first stranded wires 2, specifically the plurality of outer circumference first stranded wires 2B, and the twist direction of the plurality of first wires 21 and the twist direction of the plurality of second wires 31 are the same.

In the present embodiment, the first stranded wires 2 are formed with the same diameter, with the number of the first wires 21 used in each of the first stranded wires 2 being the same. Note that the diameter of the first stranded wires 2 refers to the diameter of an imaginary circle that is the smallest circle encompassing all of the plurality of first wires 21 forming the first stranded wire 2, as seen from a cross-section of the first stranded wire 2. This definition also applies to the diameter of stranded wire in the second to fourth embodiments described below. Note that the diameter of the central first stranded wire 2A may be different from the diameter of the outer circumference first stranded wires 2B.

The number of the outer circumference first stranded wires 2B in the insulated wire 1 may be from 5 to 8, for example. This allows the outer circumference first stranded wires 2B to be disposed in a substantially circular shape around the central first stranded wire 2A and helps stop gaps forming in the insulated wire 1 as much as possible. In the present embodiment, the number of the outer circumference first stranded wires 2B is six.

Second Stranded Wire Group 30

As shown in FIG. 5, the plurality of second stranded wires 3 are formed as a second stranded wire group 30 and are twisted to the first side C1 in the circumferential direction C. The plurality of second stranded wires 3 may be twisted to the first side C1 in the circumferential direction C by rotating the plurality of second stranded wires 3 around the plurality of first stranded wires 2. The bundle of the plurality of second stranded wires 3 is defined as the second stranded wire group 30. When the plurality of second stranded wires 3 are twisted, the plurality of first stranded wires 2 may be barely twisted in the circumferential direction C. Furthermore, the twist direction the plurality of second stranded wires 3 and the twist direction of the plurality of first wires 21, the twist direction of the plurality of second wires 31, and the twist direction of the plurality of first stranded wires 2 are the same.

In the second stranded wire group 30, the plurality of second stranded wires 3 are disposed in a spiral-like manner. In the present embodiment, the second stranded wires 3 are disposed side by side in the circumferential direction C in one level in the radial direction. The number of the second stranded wires 3 in the insulated wire 1 is a number that allows the second stranded wires 3 to be disposed in a substantially circular shape around the first stranded wire group 20 and helps stops gap forming in the insulated wire 1 as much as possible. The number of the second stranded wires 3 may be from 6 to 3500.

The lay length of the plurality of first stranded wires 2 in the first stranded wire group 20 and the lay length of the plurality of second stranded wires 3 in the second stranded wire group 30 can be the same. Also, the lay length of the plurality of first stranded wires 2 and the lay length of the plurality of second stranded wires 3 can be different.

When the plurality of first stranded wires 2 are twisted to form the first stranded wire group 20, the first stranded wires 2 are compressed as appropriate. This allows the gaps between the first stranded wires 2 to be decreased and the cross-sectional shape of the first stranded wire group 20 to be formed in a substantially perfect circular shape.

Also, when the plurality of second stranded wires 3 are twisted to form the second stranded wire group 30, the second stranded wires 3 and the first stranded wires 2 are compressed as appropriate. This allows the gaps between the first stranded wires 2 and the gaps between the second stranded wires 3 to be decreased and the cross-sectional shape of the second stranded wire group 30 to be formed in a substantially perfect circular shape.

Note that FIG. 1 shows the insulated wire 1 with the arrangement of the first stranded wires 2 and the second stranded wires 3 clearly shown. However, in reality, preferably, no gaps are formed between the first stranded wires 2 and the second stranded wires 3. This also applies to the second to fourth embodiments described below.

Cover Member 4

As shown in FIG. 1, the cover member 4 is formed in a cylindrical shape at the outermost circumferential portion of the insulated wire 1. The cover member 4 insulates the plurality of first stranded wires 2 and the plurality of second stranded wires 3 as a whole from the surroundings, and protects the plurality of first stranded wires 2 and the plurality of second stranded wires 3 as a whole from water and the like and. The cover member 4 is formed from a resin material having insulating properties.

In the present embodiment, a shield member for shielding from electromagnetic waves is not disposed on the inner circumference of the cover member 4. However, a shield member may be disposed on the inner circumference of the cover member 4.

Method of Manufacturing

A method of manufacturing the insulated wire 1 according to the present embodiment will be described. Firstly, as shown in FIG. 2, the plurality of first wires 21 are bundled, and then the bundle of the plurality of first wires 21 is twisted to the first side C1 in the circumferential direction C to form the first stranded wire 2. Also, as shown in FIG. 3, the plurality of second wires 31 are bundled, and then the bundle of the plurality of second wires 31 is twisted to the first side C1 in the circumferential direction C to form the second stranded wire 3.

Next, as shown in FIG. 4, the plurality of first stranded wires 2 are bundled, and then the bundle of the plurality of first stranded wires 2 is twisted to the first side C1 in the circumferential direction C to form the first stranded wire group 20. Here, the first stranded wire group 20 can be formed by rotating the plurality of outer circumference first stranded wires 2B about the central first stranded wire 2A.

Then, the plurality of second stranded wires 3 are disposed side by side in the circumferential direction C around the outer circumference of the first stranded wire group 20. As shown in FIG. 5, the plurality of second stranded wires 3 are twisted to the first side C1 in the circumferential direction C about the first stranded wire group 20 to form the second stranded wire group 30. Then, the cover member 4 is formed around the second stranded wire group 30, and the insulated wire 1 is manufactured. Note that when forming the first stranded wires 2, the second stranded wires 3, the first stranded wire group 20, and the second stranded wire group 30, a twisting device may be used.

### Effects

A first advantage of the insulated wire 1 of the present embodiment is that two kinds of stranded wires with different wire diameters, the first stranded wires 2 and the second stranded wires 3, are used. By using the second stranded wires 3 including the second wires 31 with a wire diameter smaller than that of the first wires 21, the flexibility of the insulated wire 1 can be ensured. Also, by using the first stranded wires 2 including the first wires 21 with a wire diameter greater than that of the second wires 31, the strength of the insulated wire 1 can be ensured.

A second advantage of the insulated wire 1 of the present embodiment is that the plurality of first stranded wires 2 including the first wires 21 are twisted together and the plurality of second stranded wires 3 including the second wires 31 are twisted together at the outer circumference surrounding the plurality of first stranded wires 2. In other words, the plurality of first stranded wires 2 and the plurality of second stranded wires 3 are separately twisted. This can appropriately increase the vibrational strength of the insulated wire 1. Also, because the plurality of first stranded wires 2 and the plurality of second stranded wires 3 are separately twisted, the twisting operation is easily performed. This can prevent the occurrence of insufficient twisting.

A third advantage of the insulated wire 1 of the present embodiment is that the plurality of second stranded wires 3 are disposed at an outer circumferential portion surrounding the first stranded wires 2 in a state of being twisted together. In the present embodiment, the second stranded wires 3 including the second wires 31 with a wire diameter smaller than that of the first wires 21 are disposed on the outer circumferential side of the insulated wire 1. This can further appropriately ensure the flexibility and strength of the insulated wire 1.

Specifically, by disposing the first wires 21 with greater wire diameter and strength on the center side of the insulated wire 1, the strength of the insulated wire 1 can be effectively ensured. Also, by disposing the second wires 31 with a smaller wire diameter and less strength on the outer circumferential side of the insulated wire 1, the flexibility of the insulated wire 1 can be effectively ensured.

FIG. 6 schematically shows how the strength and flexibility of the wire changes relative to the diameter of the wire (wire diameter). When the wire diameter is great, the strength is great, but the flexibility is low. When the wire diameter is low, the strength is low, but the flexibility is great. Flexibility and strength have a negative correlation that makes increasing both difficult.

The insulated wire 1 of the present embodiment has a configuration in which the negative correlation between flexibility and strength is relaxed and both flexibility and strength can be increased. When the insulated wire 1 is bent, the compressive stress on the wire at a position on the inner side of the bent shape increases, and the tensile stress on the wire at a position on the outer side of the bent shape increases. Thus, by disposing the second wires 31 with excellent flexibility on the outer circumferential side of the insulated wire 1, the flexibility of the insulated wire 1 can be increased, allowing the insulated wire 1 to easily bend.

Also, when the insulated wire 1 receives vibration when a vehicle is running or the like, vibrations of a specific frequency may cause resonance to occur in the insulated wire 1. Resonance occurs when the frequency of the vibration caused by a vehicle running or like overlaps with the natural frequency of the insulated wire 1. The diameter of the wires disposed on the center side of the insulated wire 1 has a greater impact in determining the natural frequency of the insulated wire 1. Increasing the diameter of the wires disposed on the center side of the insulated wire 1 decreases the natural frequency of the insulated wire 1, thus making the insulated wire 1 resistant to vibration.

Thus, according to the present embodiment, by combining these three advantages, the insulated wire 1 can be formed with a good balance between flexibility and strength, with both flexibility and strength being appropriately ensured.

### Second Embodiment

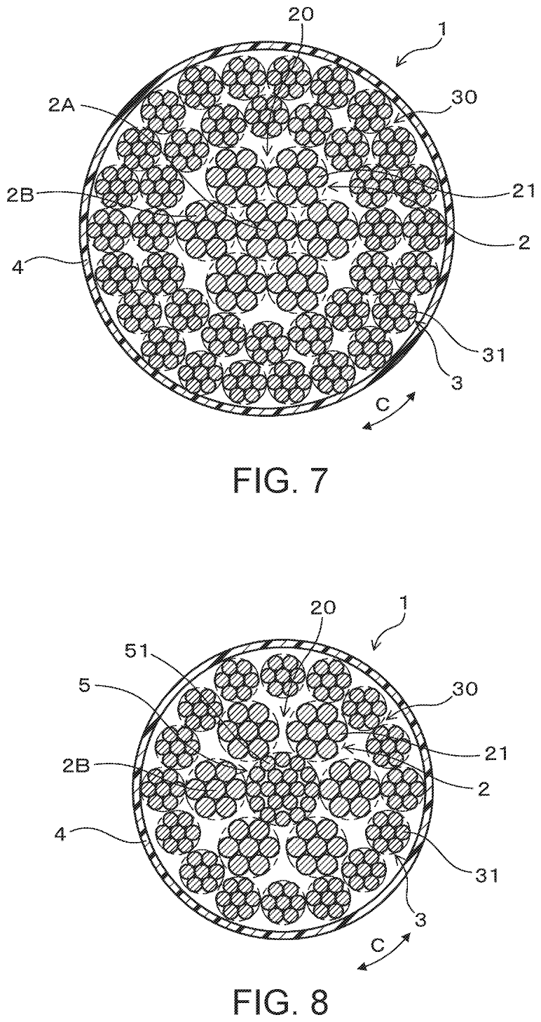

In the insulated wire 1 of the present embodiment, the configuration of the first stranded wires 2 and the second stranded wires 3 is different from that in the first embodiment. As shown in FIG. 7, the plurality of second stranded wires 3 disposed on the outer circumferential side of the first stranded wire group 20 may be disposed side by side in two levels in the radial direction. In this case, the flexibility of the insulated wire 1 can be more appropriately ensured.

For the second embodiment and the following embodiments, as in the first embodiment, the gaps formed in the insulated wire 1 are kept to a minimum by the first wires 21, the second wires 31, and the like being compressed and the cross-sectional shape of the insulated wire 1 being formed in a substantially perfect circular shape.

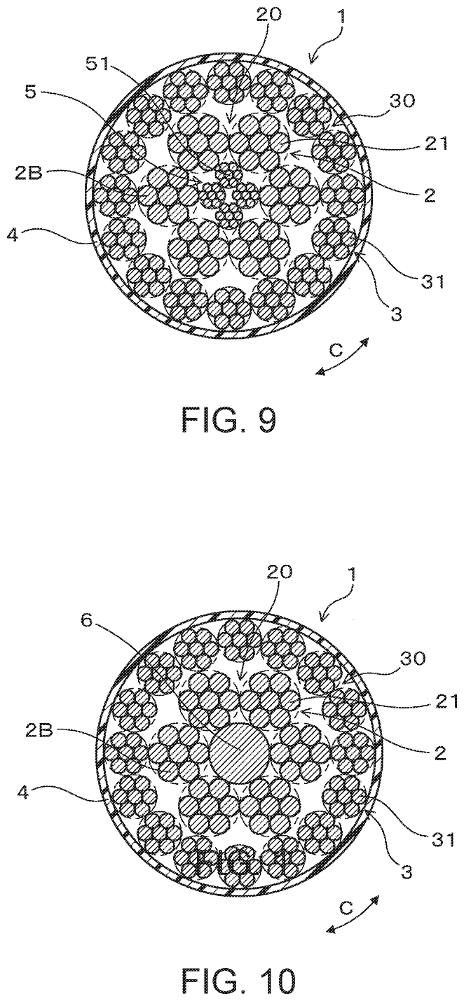

As shown in FIGS. 8 and 9, a third stranded wire 5 may be disposed in the center portion of the insulated wire 1. The third stranded wire 5 includes a plurality of third wires 51 with a different wire diameter from the first wires 21 twisted together. Also, the plurality of first stranded wires 2 are disposed at the outer circumference surrounding the third stranded wire 5.

In this case, as shown in FIG. 8, a single third stranded wire 5 may also be disposed instead of the central first stranded wire 2A described in the first embodiment. Also, as shown in FIG. 9, a plurality of third stranded wires 5 may also be disposed instead of the central first stranded wire 2A according to the first embodiment. The wire diameter of the third wires 51 of the third stranded wire 5 may also be the same as the wire diameter of the second wires 31 of the second stranded wires 3. Also, the wire diameter of the third wires 51 of the third stranded wire 5 may also be different from the wire diameter of the first wires 21 and the wire diameter of the second wires 31.

As shown in FIG. 10, a single thick conductor 6 may also be disposed instead of the central first stranded wire 2A of the plurality of first stranded wires 2 according to the first embodiment. The diameter of the conductor 6 is greater than the diameter of the first wires 21 and the diameter of the second wires 31. In this case, the strength of the insulated wire 1 can be effectively increased.

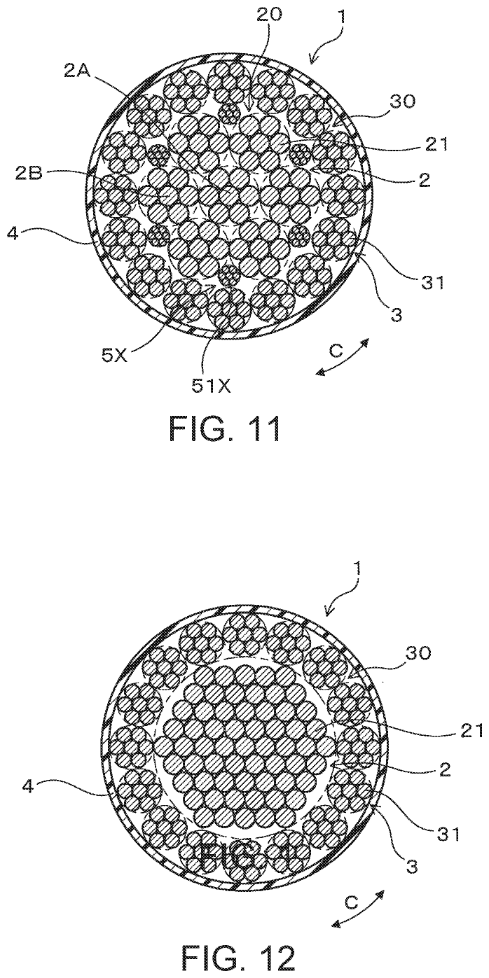

Also, as shown in FIG. 11, third stranded wires 5X different from the first stranded wires 2 and the second stranded wires 3 may also be disposed in the gaps in the insulated wire 1 including the first stranded wires 2 and the second stranded wires 3. The diameter of the third stranded wires 5X may be smaller than the diameter of the first stranded wires 2 and the diameter of the second stranded wires 3. In this case, the gaps in the insulated wire 1 are removed as much as possible, allowing the proportional area of the conductor in the insulated wire 1 to be increased.

In the insulated wire 1 of the present embodiment, other configurations, effects, and the like are similar to those of the first embodiment. Also, constituent elements of the present embodiment and constituent elements of the first embodiment that share the same reference numeral are similar.

### Third Embodiment

FIG. 12 shows the present embodiment in which a single first stranded wire 2 is disposed on the inner side (center side) of the plurality of second stranded wires 3. The present embodiment is different from the first embodiment in that the present embodiment includes a single first stranded wire 2. Other configurations are similar to that of the first embodiment. The diameter of the first stranded wire 2 in the present embodiment is greater than the diameter of the second stranded wires 3.

In the insulated wire 1 of the present embodiment, the single first stranded wire 2 including the plurality of first wires 21 twisted together is formed as a single bundle. In the insulated wire 1 of the present embodiment, by using the first stranded wire 2 including the first wires 21, which, out of the first wires 21 and the second wires 31, are located on the center side and have a greater wire diameter, the strength of the insulated wire 1 can be appropriately increased. Also, by using the second stranded wire group 30 including the second wires 31, which are located on the outer circumferential side and have a smaller wire diameter, the flexibility of the insulated wire 1 can be appropriately increased.

In the insulated wire 1 of the present embodiment, other effects and the like are similar to those of the first embodiment. Also, constituent elements of the present embodiment and constituent elements of the first and second embodiments that share the same reference numeral are similar.

### Fourth Embodiment

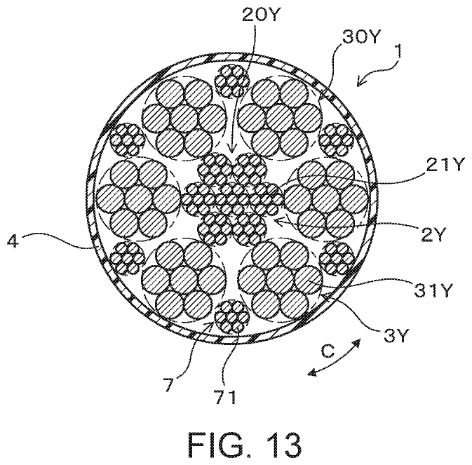

FIG. 13 shows the present embodiment in which the wire diameter of first wires 21Y of a plurality of first stranded wires 2Y disposed in the center portion (center side) of the insulated wire 1 is smaller than the wire diameter of second wires 31Y of a plurality of second stranded wires 3Y disposed in the outer circumferential portion (outer circumferential side) of the insulated wire 1.

The plurality of second stranded wires 3Y of the present embodiment are disposed side by side in one level in the radial direction. The first stranded wire group 20 including the plurality of first stranded wires 2Y and a second stranded wire group 30Y including the plurality of second stranded wires 3Y may be twisted in a similar manner as described in the first embodiment. Also, gap stranded wires 7 are disposed alternately and side by side the second stranded wires 3Y in the circumferential direction C in the gaps formed on the outer circumferential side between the second stranded wires 3Y. The gap stranded wires 7 include a plurality of gap wires 71 twisted together and have a diameter smaller than the diameter of the second stranded wires 3Y.

The diameter of the second stranded wires 3Y refers to the diameter of an imaginary circle that is the smallest circle encompassing all of the plurality of second wires 31Y forming the second stranded wire 3Y. The diameter of the gap stranded wire 7 is defined in a similar manner.

The configuration of the gap stranded wire 7 of the present embodiment is the same as the first stranded wires 2Y. Also, the configuration of the gap wires 71 is the same as the first wires 21Y. The gap stranded wire 7 may include a third wire with a diameter different from the diameter of the first wires 21Y and the second wires 31Y.

Also according to the present embodiment, the insulated wire 1 can be formed with a good balance between flexibility and strength. However, because the first wires 21Y with a smaller wire diameter than the second wires 31Y are disposed in the center portion of the insulated wire 1, an increase in flexibility and strength is more difficult to achieve compared to the first embodiment.

In the insulated wire 1 of the present embodiment, other configurations, effects, and the like are similar to those of the first to third embodiment. Also, constituent elements of the present embodiment and constituent elements of the first to third embodiment that share the same reference numeral are similar.

### OTHER EMBODIMENTS

In the first to fourth embodiments, the plurality of first stranded wires 2, 2Y and the plurality of second stranded wires 3, 3Y can be separately twisted and can be twisted at the same time. However, because the inwardly disposed stranded wires become increasingly harder to twist, the twisting device needs a way to handling this.

Also, the configuration of the first stranded wires 2, 2Y, the second stranded wires 3, 3Y, and the like described in the first to fourth embodiment are examples. The present disclosure is not limited to these embodiments, and other different embodiments can be configured without departing from the scope of the present disclosure. Furthermore, the present disclosure includes various modified examples, modified examples including equivalents, and the like.

1. An insulated wire, comprising:
a plurality of first stranded wires each formed by twisting a plurality of first wires;
a plurality of second stranded wires each formed by twisting a plurality of second wires, the second wires having a wire diameter different from a wire diameter of the first wires; and
a cover with insulating properties that covers an entire outer circumference of the plurality of first stranded wires and the plurality of second stranded wires as a whole, wherein
the plurality of first stranded wires are twisted in a circumferential direction, and
the plurality of second stranded wires are twisted in the circumferential direction at an outer circumference surrounding the plurality of first stranded wires.

2. The insulated wire according to claim 1, wherein
the wire diameter of the second wires is smaller than the wire diameter of the first wires.

3. The insulated wire according to claim 1, wherein
the plurality of second stranded wires and the plurality of first stranded wires are twisted in an identical direction.

4. The insulated wire according to claim 1, wherein
the plurality of first stranded wires are formed by a central first stranded wire disposed in a center of the insulated wire and a plurality of outer circumference first stranded wires disposed at an outer circumference surrounding the central first stranded wire.

5. The insulated wire according to claim 1, wherein
a third stranded wire formed by twisting a plurality of third wires is disposed in a center of the insulated wire, the third wires having a wire diameter different from the wire diameter of the first wires; and
the plurality of first stranded wires are disposed at an outer circumference surrounding the third stranded wire.

6. The insulated wire according to claim 1, wherein
the plurality of second stranded wires are disposed in one level or two levels in a radial direction.

7. The insulated wire according to claim 1, wherein
the plurality of second stranded wires are disposed side by side in one level in a radial direction; and
gap stranded wires are disposed alternately and side by side the second stranded wires in the circumferential direction in gaps formed between the second stranded wires on an outer circumferential side, the gap stranded wires each being formed by twisting a plurality of gap wires, and having a diameter smaller than a diameter of the second stranded wires.

8. An insulated wire, comprising:
one or a plurality of first stranded wires each formed by twisting a plurality of first wires;
a plurality of second stranded wires each formed by twisting a plurality of second wires, the second wires having a wire diameter smaller than a wire diameter of the first wires; and
a cover with insulating properties that covers an entire outer circumference of the plurality of first stranded wires and the plurality of second stranded wires as a whole, wherein
the one or plurality of first stranded wires are disposed in a center of the insulated wire, and
the plurality of second stranded wires are disposed in an outer circumferential portion surrounding the one or plurality of first stranded wires, in a state of being twisted in a circumferential direction.
